(19) United States
(12) Patent Application Publication
(10) Pub. No.: US 2010/0119831 A1
(43) Pub. Date: May 13, 2010

(54) IN-LINE CONTINUOUS FORMING OF A COATED PLASTIC SUBSTRATE

(75) Inventor: Vittorio BELLUZ, Charlotte, NC (US)

Correspondence Address: OBLON, SPIVAK, MCCLELLAND MAIER & NEUSTADT, L.L.P., 1940 DUKE STREET, ALEXANDRIA, VA, 22314, US

(73) Assignee: DELLE VEDOVE USA, INC., Charlotte, NC (US)

(21) Appl. No.: 12/270,334

(22) Filed: Nov. 13, 2008

(51) Int. Cl. B05D 3/06; C08F 2/46; B32B 9/04

(52) U.S. Cl. 428/411.1; 427/492; 118/641

(57) ABSTRACT

A process includes vacuum coating a shaped profile with a UV curable coating composition and subsequently curing the coated shaped profile to form a shaped profile having a uniform coated, cured coating. The curing is carried out with a pulsed UV device operated at a pulse frequency at pulse power such that the coating composition is uniformly cured over the coated surfaces of the shaped profile. The process is carried out continuously to coat and cure a shaped profile moving lengthwise through sequentially arranged coating and curing devices. An apparatus for carrying out the process that includes a vacuum coater and a UV curing chamber.

### SUMMARY OF THE INVENTION

1. Field of the Invention

The present invention relates to a process, system and apparatus for the continuous in-line formation of a cold cured coated substrate. The process of the invention includes subjecting a substrate coated with a UV curable coating to high intensity pulsed UV light to cure the coating onto the substrate and form a continuous length of the coated and cured substrate. The apparatus of the invention includes a vacuum coater arranged in line with a pulsed UV curing device. The system of the invention includes the apparatus of the invention and ancillary equipment such as an extruder for forming a substrate.

2. Background of the Invention

The formation of substrates including profiles and “bar stock” by extruding a thermoplastic material through a die having a cut-out with a cross-sectional form in the shape of the profile and/or bar stock is conventionally known. Such conventional methods and apparatus form a substrate such as a profile and/or bar stock (e.g., rod, square tubing, shaped linear solids etc.) by first melting a thermoplastic material in an extruder and then forcing the molten thermoplastic material through a shaping device to form a profile and/or bar shape having the desired shape characteristics. Such methods and apparatus are desirably operated on a continuous basis to manufacture the substrate in an uninterrupted manner. It is desirable that such continuously formed plastic substrates are further continuously coated and/or printed with a coating material.

Some conventional methods for preparing coated profiles include first cutting an extruded continuously formed profile into lengths. The cut lengths are then coated individually or coated as a group. The coating step includes any conventional coating process such as dip coating, spray coating, printing, etc. While such methods of using cut-lengths may, in some cases, be considered a continuous process, in the context of the invention described herein a continuous process is characterized by the continuous formation of a finished product.

Conventional processes for coating shaped profiles have traditionally been carried out in a batch manner to obtain greater consistency in the coating and/or curing steps. The disadvantages of carrying out curing and/or coating in a batch manner subsequent to continuously forming a substrate by extrusion are self evident. For example, the profile must be cut into lengths of the proper size and arranged such that the cut lengths may be coated on all surfaces and then cured. After coating and curing is completed the cured coated profile lengths must be collected and bundled for transport and storage.

Inherent inefficiencies may arise from differences in the speed at which any of the individual steps of extrusion, forming, coating and/or curing is carried out. If extrusion and/or forming is carried out more quickly than the coating and/or curing, a log jamb of uncoated and uncured profile lengths accumulates which requires clearing by an operator.

On the other hand carrying out continuous coating and curing of a shaped thermoplastic substrate is complicated by the high temperatures associated with conventional UV curing devices. Most conventional curing is carried out using UV light sources such as mercury vapor lamps. Mercury vapor UV light sources are operated at high temperatures. Typically, a conventional mercury vapor UV lamp operates at a temperature of almost 1,000° C. While conventional UV lights are often equipped with cooling devices, large amounts of infrared heat are nonetheless formed. At least a portion of this heat is transmitted to the substrate during curing as infrared energy. The heating associated with conventional UV curing may damage, distort or warp thermoplastic shaped profiles, e.g., by melting or surface discoloration.

Pulsed UV light has been used to obtain cold-curing of UV curable coatings (see for example WO 2007/059294, incorporated herein by reference in its entirety). Continuous curing of coated substrate surfaces using pulsed UV light is complicated, however, when the substrate is moving during exposure. If the substrate is moving at a significant rate of speed while being exposed to a pulsed UV light source a “striping” effect can occur. When striping occurs the coating exhibits regularly repeating sections of cured and partially cured or uncured coating material. This problem may be addressed in conventional coating systems by slowing the rate of passage of the coated shaped profile as it passes through a curing chamber to replicate or simulate batch conditions in conventional curing processes. However, by slowing the rate of curing the entire process for making a coated cured profile is slowed thus resulting in a less economically desirable process.

In an embodiment of the present invention a cured, coated shaped profile is formed in a continuous manner on an in-line apparatus such that each step including extrusion, forming, coating, and curing is carried out to continuously on a single production line to form a substrate. In addition to the aforementioned steps, further steps such as surface treating, sanding, pressure treating, cutting, and solid shaping may be included such that the entire process is run continuously.

### DISCUSSION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 shows a high level schematic diagram of a process and apparatus for forming a cured coated shaped profile;

FIG. 2 shows a high level schematic diagram of a vacuum coater.

### DETAILED DESCRIPTION OF INVENTION

One embodiment of the invention is a process that includes continuously coating and cold curing a substrate using a pulsed UV light source to thereby continuously form a coated cured substrate. The coating is carried out with a coating device such as a vacuum coater and the cold curing is carried out with a pulsed UV light source arranged “in-line”. The coating and curing steps are arranged in-line such that different portions of a single length of a shaped profile are subjected to coating and curing at the same time as the shaped profile moves through a device or apparatus for carrying out the process. The apparatus or device used to carry out the process includes one or more process steps that are carried out one after the other such that each step of the process is a portion of a single manufacturing process. In the context of the invention an in-line process is one in which the process is completed in one pass of the substrate through the equipment. The substrate is preferably a thermoplastic profile.

The coating and curing may be carried out continuously in separate devices arranged in-line or in the same device having separate curing and coating chambers or portions. In one embodiment of the invention the curing is carried out in a curing tunnel. The substrate may be carried through the coating and curing steps on a conveyor belt system, first traveling through a coating portion and subsequently traveling through a curing portion of one or more devices. The substrate may likewise be carried and/or guided through the process on rollers and/or conveyors. Preferably the shaped profile is pushed or pulled through both the coating and curing devices such that the shaped profile is not in contact with any direct supporting means inside either the coating or curing device and/or chamber. For example, the substrate, e.g., shaped profile, may be pushed through the coating and curing devices along its direction of travel as the substrate is formed by extrusion and/or other shaping such as for example mechanical means. Separate mechanical supports may be located before and after the coating and curing devices. It is not necessary for mechanical means to be in continuous contact with the entire length of the substrate. In some embodiments of the invention portions of the substrate are free hanging, e.g., are unsupported between portions of the substrate that are supported. Mechanical supports include devices such as rollers and conveyors such as conveyor belts or other conveyor systems. In one embodiment of the invention the supporting device is a cutout that has the same geometry of the shaped profile and contacts the shaped profile at one or more locations to provide mechanical support to the profile as it passes through the process. Preferably the cutout is not in direct contact with the profile but instead contacts the profile through rollers or bumpers such as an air curtain.

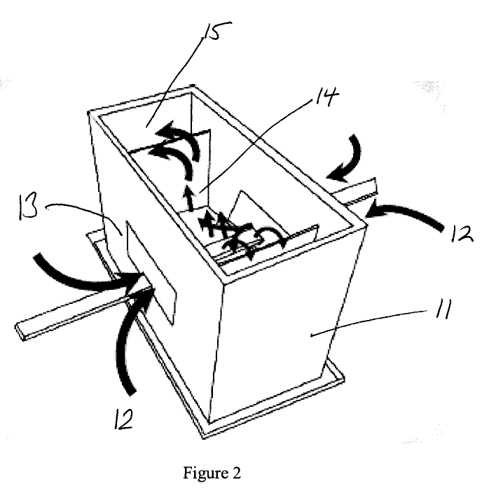

Preferable coating devices are vacuum coaters. The vacuum coater described in U.S. Pat. Nos. 7,022,189 and 4,333,417, each of which is incorporated herein by reference in its entirety, is a preferable device for carrying out the coating of the process. Vacuum coating provides a means by which the shaped profile is evenly exposed to a coating material such as a UV-curable ink, paint or other composition. A high level description of a vacuum coater is provided in FIG. 2. Commercial vacuum coaters such as the MV15, MV30, VAC612, VAC100, and/or Vacumizer coaters available from DV Systems are examples of the vacuum coaters that may be used in the process of the invention.

A vacuum coater operates by exposing the surface of a substrate to a stream of coating particles suspended in a stream of gas such as air. Vacuum coaters operate at pressures below ambient pressure. As a substrate moves through a vacuum coater substantial amounts of air flow into the vacuum coater due to the pressure differential between the ambient atmosphere and the interior of the vacuum coater. The pressure inside the vacuum coater may range from 10 millibars to slightly less than ambient pressure (e.g., slightly less than about 1,000 millibars). The pressure inside the vacuum coater is preferably between 100 and 800 millibars, more preferably 150-650, 200-600, 250-550, 300-500, 350-400, and about 400 millibars. All subranges and values between the stated values are expressly included herein, e.g., those values between 100 and 150 millibar such as 105, 110, 115, 120, 125, 130, 135, 140 and 145 millibars are expressly included herein along with any range or subrange of any of the above stated and unstated values.

A coating material is simultaneously pumped into the vacuum coater chamber as the substrate moves through the vacuum coater. The injection of coating material together with the flow of air or other gas into the vacuum coater due to the pressure differential existing between the interior of the vacuum coater and the ambient atmosphere causes the coating material to form a finely divided mist inside the vacuum coater. The flow of ambient atmosphere into the vacuum coater usually occurs at the edges of the opening of the vacuum coater that accommodates the entrance and exit of the substrate during coating. At relatively greater pressure differentials and higher gas flows a finer mist may be formed. A finer coating material mist includes airborne particles of the coating material having a relatively smaller average particle diameter.

The vacuum coater includes an in-feed gate and an exit gate. Both the in-feed and exit gates may be cutouts that correspond to the cross sectional shape of the profile. The in-feed and exit gates are larger than the cross section of the profile to permit entry, exit and travel of the profile through the vacuum coater. Preferably the in-feed and exit gates are cutouts that stand off from the profile at a distance of from 0.1 mm to 10 mm, more preferably 0.2-9 mm, 0.3-8 mm, 0.4-7 mm, 0.5-6 mm, 0.6-5 mm, 0.7-4 mm, 0.8-4 mm, 0.9-3 mm, or 1-2 mm. In some embodiments of the invention the cut off has different stand off distances from the profile at different location along the profile cross-section. The vacuum coater may also be equipped with other cutouts that are useful for adjusting the pressure and/or gas flow inside the coater. For example, the vacuum coater may have one or more holes of any shape located at the exit end, in-feed end, top or bottom. By varying the size of the holes the gas flow characteristics through the vacuum coater may be changed.

The velocity of the air flow through the vacuum coater is preferably from 1 fpm (feet per minute) to 1,000 fpm, preferably 10-900, 20-850, 30-800, 40-750, 50-700, 60-650, 70-600, 80-550, 90-500, 100-450, 150-400, 200-350, or 250-300 fpm. The volume of air flow through the vacuum coater is preferably from 100-5,000 m³/hr, preferably 150-4,500; 200-4,000; 250-3,500; 300-3,000; 350-2,500; 400-2,000; 450-1,500; 500-1,000; 550-950; 600-900; 650-850; 700-800 or about 750 m³/hr.

The pressure differential between ambient atmospheric pressure and the pressure inside the vacuum coater affects the coating process in several ways. By affecting the particle size of the coating material the pressure differential may be used as one means to optimize mist particle size to obtain improved coating on irregular surfaces. Second, at relatively greater pressure differentials the flow of ambient air into the vacuum coater and around the shaped profile increases substantially. Increased airflow passing over the coated shaped profile surface as it exists the vacuum coated chamber results in a flattening effect and forces excess coating material or overspray back into the vacuum coater chamber. High air velocity around the shaped profile during exit from the vacuum coater likewise helps ensure the formation of an even coating on all surfaces of the shaped profile.

Vacuum within the vacuum coater is provided by means of high power vacuum pumps. The vacuum pumps operate on a closed loop system to permit recycling of the coating material. Because transfer of the coating material mist onto the shaped profile is not 100% efficient, substantial amounts of coating material may leave the vacuum coater chamber and enter a vacuum producing device used to generate a vacuum in the vacuum coater. Preferably the vacuum producing device includes a separator device which removes suspended coating material from the gas flow leaving the vacuum coater. The thus separated coating material is reclaimed and may be re-injected into the vacuum coater to reduce coating material consumption and waste.

During the coating step in the vacuum coater one or more surfaces of the shaped profile may be covered or masked to avoid contact with the coating material. The mask may be in the form of a fabric and/or film layer which is pressed and/or held against the surface of the profile on which no coating is desired. The mask may be in contact with the shaped profile only during the vacuum coating or, in other embodiments of the invention, the mask is in contact with the shaped profile through both the coating and curing steps and/or the mask is in contact with the shaped profile during the entire time the shaped profile is within any of the curing and/or coating device.

In some embodiments of the invention the atmosphere entering the vacuum coater during the coating step is a gas of controlled composition. For example, instead of an inflow of ambient atmosphere a supply of an inert gas such as nitrogen may be flowed across the substrate surfaces as the substrate enters and exits the vacuum coater. In this embodiment of the invention there is lesser likelihood that the coating material reacts with any component of the inert gas. Further, by using an inert gas the humidity characteristics surrounding the shaped profile during coating and curing can better be regulated.

After exiting the vacuum coater the coated substrate comprises a coating of curable coating material on those surfaces which were exposed during coating. The amount of coating material which is present on the exposed surfaces of the substrate may range from amounts of 5-1,000 g/m² based on the weight of the coating material and the area in m² of the coated surfaces of the substrate. Preferably the coating material is present in amounts of 15-900 g/m², 20-800 g/m², 25-850 g/m², 30-800 g/m², 35-800 g/m², 40-750 g/m², 45-700 g/m², 50-650 g/m², 55-600 g/m², 60-550 g/m², 60-500 g/m², 55-450 g/m², 60-400 g/m², 65-350 g/m², 70-300 g/m², 75-250 g/m², 80-300 g/m², 85-150 g/m², 90-200 g/m², 95-150 g/m², 100-190 g/m², 110-180 g/m², 110-170 g/m², 130-160 g/m², 140-150 g/m², and about 145 g/m². When measured in terms of thickness the coating material may be present as a film on the shaped profile having a thickness of from about 0.5 mil to about 5 mil, preferably 1-4.5, 1.5-4, 2-3.5, 2.5-3, and about 2.75 mil.

Preferably the coating material consists of a UV curable composition. Most preferably the coating material consists of a material in which each component undergoes polymerization or curing when exposed to pulsed UV light to form a continuous solid coating that is in direct and continuous contact with the surface of the substrate after the UV curing step. In other embodiments of the invention the coating material includes one or more additives that do not directly undergo a chemical change during curing but are nonetheless present in the solid cured coating after exposure to pulsed UV light. Such additional components may include inert fillers and other additives and/or adjuvants that may provide stabilization against discoloration, improved heat resistance, scratch resistance, color in the cured coating such as hindered amine light stabilizers, pigments, dyes and fillers.

The substrate, e.g., shaped profile, comprising a coating of uncured coating material is subsequently directed into a curing chamber and/or device. The curing chamber and/or device is separated from the coating chamber and/or device in a manner such that only minor amounts of the UV light generated in the curing chamber enters the vacuum coating chamber and/or device, preferably no UV light from the curing chamber and/or device enters the vacuum coater or vacuum coating device. Preferably no more than 0.1% of the UV light in the curing chamber enters the vacuum coater, more preferably no more than 0.05, 0.01, 0.005, 0.001% and most preferably no UV light from the curing chamber and/or device enters the vacuum coater device and/or chamber.

Preferably the delay between the exit of the shaped profile from the vacuum coater to entry of the coated shaped profile into the curing chamber is less than 1 second. By minimizing transfer time between coating and curing there is less likelihood that undesirable oxidation, evaporation of the coating material, or aging of the uncured coating take place during the process of the invention.

Preferably the coated substrate enters the curing device immediately after exiting the vacuum coater. Preferably the vacuum coater and curing devices are separated by a distance of no more than 1 meter, preferably no more than 0.5, 0.4, 0.2, 0.1, 0.05, 0.04, 0.03, 0.02, 0.01, 0.005, 0.002 meters.

In some embodiments of the invention the process is carried out continuously with a relaxing step. During relaxing the coated substrate is permitted to rest in ambient atmosphere. The resting is carried out such that the profile continues to move during the relaxing but the profile is not concurrently subjected to curing, coating or other steps which may affect the surface of the substrate. Relaxing increases the ability of the coating to flatten before curing or permit additional cooling of the cured and/or uncured surface of the substrate. Relaxing may be carried for up to 30 seconds, preferably up to 25, 20, 15, 10, 9, 8, 7, 6, 5, 4, 3, 2, 1, 0.5 seconds after any of extruding, coating, and/or curing. In an especially preferred embodiment the relaxing is carried out by including a dry section in line with the coating and curing steps. For example, after coating the coated substrate may travel in ambient air for a distance of up to 10 meters before the substrate is subjected to any further processing steps such as curing, sanding, coating etc.

The coated substrate has a thin, even layer of coating material on those surfaces which are desired to be coated. The coated substrate is subjected to cold curing with pulsed UV light at low or ambient temperature. Preferably during the curing the temperature of the substrate is raised by no more than 50° C., more preferably no more than 45° C., 40° C., 35° C., 30° C., 25° C., 20° C., 15° C., 10° C., 5° C., 4° C., 3° C., 2° C., 1° C., 0.5° C. or 0.2° C. Some heating may occur for curing processes which are exothermic. In other embodiments of the invention the curing chamber and/or device is supplied with a cold inert gas supply to further lower the temperature within the curing device.

The cold curing is preferably carried out at ambient temperature, most preferably in the range of from 50 to 90° F. Preferable curing temperature include 55, 60, 65, 70, 75, 80, and 85° F. Other temperature may also be used to carry out the cold curing. For example, the cold curing may be carried out at a temperature that is lower than ambient temperature. For example the curing chamber or device may be cooled to a temperature that is 2, 4, 5, 10, 15, 20, 25, 30, 35, 40, 45 or 50° C. cooler than ambient temperature. In other embodiments of the invention the curing chamber or device is heated to a temperature that is 2, 4, 5, 10, 15, 20, 25, 30, 35, 40, 45 or 50° C. above ambient temperature. All ranges or subranges of any of the above stated and unstated temperature values are expressly included herein.

One or more additional steps and/or devices may be carried out or be present between the vacuum coater and the curing device and/or chambers. For example, a second or further coating device and/or chamber may be present in line and in tandem with a first vacuum coater. The first and second vacuum coaters may apply the same coating composition or different coating compositions. In a preferred embodiment the process is carried out with a device or apparatus that includes only a single vacuum coater.

Other steps that may be carried out after vacuum coating and before curing include further shaping of the shaped profile, cutting of the shaped profile, fitting the shaped profile with one or more attachments, applying an adhesive to one or more surfaces of the shaped profile, heating the shaped profile, cooling the shaped profile and the like. A device that may be present between the vacuum coater and the curing chamber includes devices such as heaters, coolers, cutters, shapers, sanders, rollers, and the like. Steps that include wiping such applying a liquid or powder material by brush, fabric or other applicator may also be included. Wiping may also be used to remove, smoothen or effect surface finish characteristics by which the coating is removed, textured and/or patterned.

The curing is preferably carried out in an ambient atmosphere. In other embodiments of the invention the curing is carried out in a controlled atmosphere such as a dehumidified atmosphere or an atmosphere that consists essentially of inert gases such as nitrogen and/or argon.

Preferably the pulsed UV light source is a high energy light source having a power of 1 kW or greater. Preferably, the UV light source has a system power of at least 2, 4 or 6 kW. The UV light source may be one or more of the light sources commercially available from, for example, Xenon Corporation, including the Xenon RC-901 and RC 902 lamp systems. In order to avoid striping while a coated substrate is continuously passed by a pulsed UV lamp, the UV light source preferably has a flash frequency of at least 10 pps, more preferably at least 20 pps, 30 pps, 40 pps, 50 pps, 60 pps, 70 pps, 80 pps, 90 pps and up to 100 pps. Preferably a UV lamp having a length that is at least as long as the width of the shaped profile is used to carry out the cold curing. More than one lamp may be used, preferably, a separate lamp is used for each exposed and coated surface of the substrate, e.g., shaped profile. For example, a top lamp is used to expose the top surface of the coated but uncured shaped profile. Likewise, side lamps may be used to expose separate side, top and/or bottomsurfaces of the coated but uncured shaped profile. Each lamp may be a separate lamp or may include two or more lamps in tandem to provide additional curing power and/or offsetting flash frequency. The pulsing of different lamps may be coordinated to ensure greater or faster curing and/or to avoid striping.

By virtue of carrying out cold curing the plastic substrate is not subjected to thermal stresses which may lead to warping or other deformation. Further, the cold curing temperature avoids discoloration that is often associated with effects such as scorching or thermal decomposition of plastics.

The use of cool pulsed UV light allows operation of the curing step in a manner such that the UV lamp is only used when needed. In contrast to conventional UV lamps a pulsed UV lamp does not require a warm up period. Thus, when the process is stopped for maintenance and/or to permit operators to take a break, there is no energy consumption by the pulsed UV source.

In a preferred embodiment the process of the invention includes forming a shaped profile by extruding a plastic material through a shaped die. The extruding is carried out by melting and kneading, and optionally, mixing a plastic material and subsequently forcing the molten plastic material through a shaped die or form to thereby form the shaped profile. The extruding is carried out continuously such that an endless length of the shaped profile is extruded through the shaped die along the lengthwise axis of the shaped profile. As the shaped profile exits the shaped die lengthwise it cools to form the shaped profile. The shaped profile may be immediately directed into the vacuum coater for application of a coating mixture or the shaped profile may first be cooled further to form a solid rigid length of the shaped profile which is subsequently passed through the vacuum coater and the curing apparatus. Preferably the shaped profile is cooled to a temperature of around 200° C., preferably 180, 160, 140, 120, 100, 90, 80, 70, 60, 50, 40, 30, 20° C. before entering the vacuum coater.

The extruder operates at a temperature sufficient to melt and/or plasticize the plastic material. The temperature of the extruder is preferably greater than the melting temperature of the plastic material. During the extruding the plastic material may be mixed with other materials such as reinforcing agents, chemical additives, and/or colorants. The type of extruder is not particularly limited. Single screw, double screw, multi screw extruders may be used in the process of the invention. In other embodiments a melt pump may be used to force a molten plastic material through the shaped die to form the shaped profile.

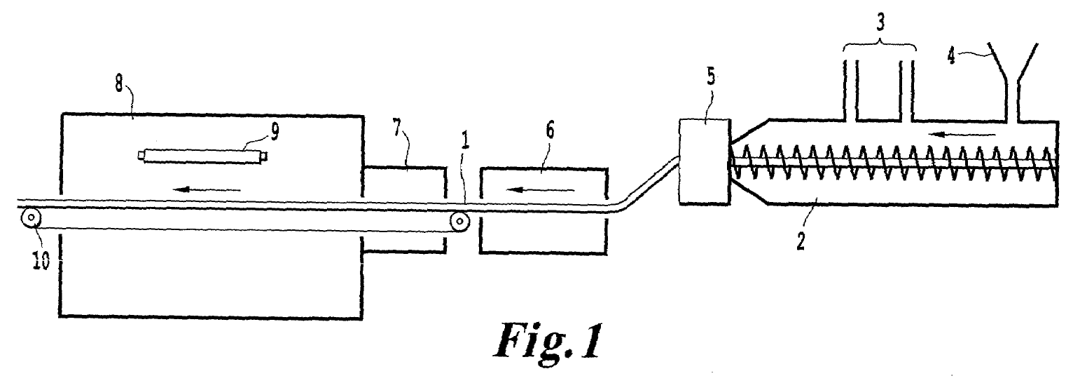

FIG. 1 shows a high-level schematic of the process and apparatus of the invention. The substrate (1), e.g., a shaped thermoplastic profile, is first formed by extruding a thermoplastic material with an extruder (2). The extruder includes ports (3) for adding additives and/or for devolatilizing the thermoplastic material. The thermoplastic material may be added to the extruder through the port (4). The thermoplastic material exits the extruder and passes through a die (5) then passes through a cooling device such as a water bath (6). The cooled and solidified profile passes through the vacuum coater during which a coating is applied to the profile. The coated profile passes through the UV chamber (8) which includes a source of pulsed UV light (9). The profile may be supported on a conveyor system (10) as is passes through the process and apparatus.

FIG. 2 shows a schematic diagram of a vacuum coater. As the substrate (e.g., thermoplastic profile) enters the vacuum coater (11) at an entrance (13) ambient air (12) also enters the vacuum coater. The ambient air and the coating composition (14) mix inside the vacuum coater. Excess coating composition flows with ambient air to a catchment basin (15).

Plastic material may be any thermoplastic material such as a polyolefin, polycarbonate, polyamide, polyether, polysulfone, polyvinyl chloride (PVC) and the like. The plastic material includes compositions that comprise a mixture of thermoplastic materials and, for example, cellulose-based materials such as engineered wood.

Obviously, numerous modifications and variations of the present invention are possible in light of the above teachings. It is therefore to be understood that within the scope of the appended claims, the invention may be practiced otherwise than as specifically described herein.

1. A process for continuously forming a cured coating on a thermoplastic profile, comprising:
continuously feeding, in a lengthwise orientation, a thermoplastic profile into a vacuum coater;
coating the thermoplastic profile in the vacuum coater to apply a coating composition onto one or more surfaces of the thermoplastic profile and form a coated profile; and
curing the coating of the coated profile with pulsed UV light as the coated profile moves continuously through a curing chamber to form a cured profile;
wherein the vacuum coater applies the composition to the shaped profile at a pressure of from 100 to 900 millibars, and
wherein the pulsed UV light includes pulses of UV light having a duration of 100 microseconds or less at intervals of 10 microseconds or greater.

2. The process of claim 1, further comprising:
forming the thermoplastic profile by extruding a thermoplastic composition through a shaped die.

3. The process of claim 2, wherein the thermoplastic profile is continuously formed by the extruding; and the thermoplastic profile is continually coated and cured as the shaped profile moves lengthwise through a coating chamber and the curing chamber.

4. The process of claim 1, wherein the coating includes flowing a gas over the surfaces of the coated profile.

5. The process of claim 4, wherein after passing the gas over at least one surface of the coated profile a uniform layer of the coating composition is present on one or more surfaces thereof.

6. The process of claim 1, wherein the curing is carried out no later than 10 seconds after the coating.

7. The process of claim 1, wherein after the curing the temperature of the cured profile immediately after the curing no more than 5° C. greater than the temperature of the coated profile.

8. The process of claim 1, wherein the thermoplastic profile moves lengthwise at a speed of from 0.5 to 15 m/s.

9. The process of claim 1, wherein the curing forms a cured profile having a uniform and homogeneous cured coating on one or more surfaces.

10. A shaped profile obtained by the process of claim 1.

11. An apparatus for carrying out the process of claim 1, comprising:
a vacuum coater and a UV pulsed curing device,
wherein the vacuum coater and the pulsed UV curing device are connected by a passage capable of transporting the thermoplastic profile, the coated profile and the cured profile in a lengthwise orientation.
